(19) United States
(12) Patent Application Publication
(10) Pub. No.: US 2003/0168834 A1
(43) Pub. Date: Sep. 11, 2003

(54) Method for producing markings and a mobile device for carrying out this method

(76) Inventor: Franz Ulrich, Wilen b Wollerau (CH)

Correspondence Address: WENDEROTH, LIND & PONACK, L.L.P., 2033 K STREET N. W., SUITE 800, WASHINGTON, DC, 20006-1021, US

(21) Appl. No.: 10/381,805

(22) PCT Filed: Jul. 9, 2001
(86) PCT No.: PCT/CH01/00427

(30) Foreign Application Priority Data
Oct. 2, 2000 (CH) 1930/00

(51) Int. Cl. B60S 1/00

(52) U.S. Cl. 280/727

(57) ABSTRACT

The invention relates to a method for producing large-surface markings such as patterns, images, text, company logos, signs or decorative markings. A marking head (5) that is positioned on a mobile device (1), preferably a vehicle, is moved along the surface to be marked with one or more e nozzles (6). Electronic control means (8) control the nozzles (6) of the marking head in accordance with the actual position of the mobile device (1), according to the model to be reproduced. This enables oversized markings to be produced, for example on areas of ground or other suitable surfaces, especially for advertising purposes.

The invention relates to a method for producing markings on a stationary surface, and also a mobil device for execution of the method.

The conventional methods for producing markings, such as e.g. printing methods, Screen printing or similar, are not suitable for marking of over-sized areas of several square metres, such as for example marking natural surfaces, such as lawns, gravel beds, streets, walls, meadows, fields of crops or similar.

The purpose of the invention is to solve the problem of creating a method and a mobile device with which markings of almost any size can be produced, even on uneven ground and on different scales following a model.

This problem is solved by the invention in that a marking head with one or more nozzles or other means arranged on a mobile device, for example a vehicle, is moved along the surface to be marked and there are electronic means of control with which the nozzles or other means of the marking head are controlled in coordination with the actual position of the mobile device in accordance with the model to be reproduced and the markings are created.

In this way almost any markings can be applied through continuous position indications of the marking head on surfaces such as sand, asphalted ground, natural ground, snowfields or similar. With such markings, patterns, images, text, company logos, decorations, direction signs etc. can also be created quickly and cheaply in several colours.

In one extremely advantageous execution, the position indication of the device is realised by a positioning system outside and/or integrated therein, for example by means of a satellite navigation system. This allows this mobile device to be permanently supervised at any location and at the same time be controlled very precisely.

An example of execution and also further advantages of the invention are explained in more detail with the aid of the drawings, which show:

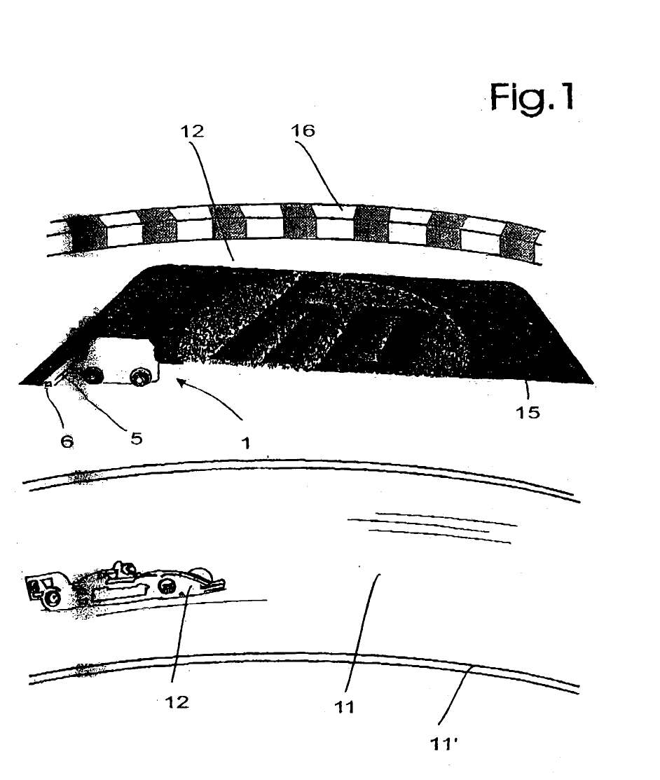

FIG. 1. a schematic illustration of a large-area marking in the course of being produced in accordance with the method of the invention, and

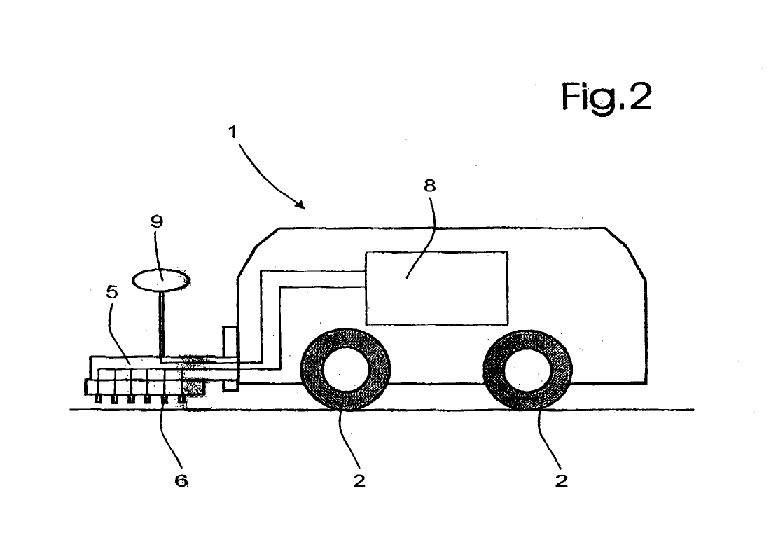

FIG. 2 a schematic lateral view of a mobile device according to invention.

FIG. 1 shows schematically an arrangement in the domain of racing sports, for example, Formula 1. For this purpose there are usually provided a race track 11 with track edges 11′, a racing car 12 indicated, and next to the track 11 over-run zones arranged for safety purposes, where the latter are now usually designed as gravel bed 12 and terminating barriers 16.

To exploit this extremely large gravel bed 12, on which no objects whatsoever, such as advertising hoardings, may be placed, a marking 15 is produced according to the method of the invention. This means these clear areas can be used in particular for advertising purposes, without any additional risks of any kind arising the drivers.

For the production method of this marking 15, in this case laid out as a company logo, a marking head 5 with one or more nozzles 6 on a mobile device, preferably a vehicle is moved along the area to be marked 12. Electronic control means are provided in the device 1 with which the nozzles 6 of the marking head 5 are controlled in co-ordination with the actual position of the device 1 according to the model to be reproduced.

FIG. 2. shows a motor-driven mobile device, in this case a remote-controlled vehicle 1 which is provided with wheels 2 for forward movement. The marking head 5 is advantageously height-adjustable and has one or more spray nozzles 6 arranges in rows, each fed from a dye tank. The number of rows, seen transversely to the direction of movement of the device, depends on the requirement as to whether one, two or more colours are to be printed. So for example for a two-colour print in the direction of travel, there must be two nozzle each with the respective dye. A control box 8 contains the electronic control means, including computer with integrated software for converting the control signal output by the model.

The position indication of the device must be made in real time and with the greatest possible accuracy. For example a satellite navigation system (differential GPS) is highly suitable for this, or a motorised tachymeter with automatic target tracking which each allow position indication of the device to the exact centimetre. The device can additionally be equipped with at least one further feedback sensor, which informs the control means of the path already covered and/or drift from the course, in order to make any fine corrections which may become necessary as a result.

During the spray process, the device is advantageously controlled in such a way that it runs in parallel tracks. At the end of the respective track, it is turned and brought into a position which advantageously connects to the previously sprayed track, as can be seen from FIG. 1. It is, however, also possible for the device to travel along curved tracks and thereby for example a stripe of any width desired can be printed along a curve.

In this way, large-scale graphical elements can be applied onto any backing, even if it is highly uneven. Such markings can be used either for providing information, for example on streets and squares, or for advertising purposes, such as in arrivals corridors at airports.

In a specific marking according to invention, for example a company logo on a gravel bed as illustrated for example in FIG. 1—the method is as follows:

Firstly, the topography of the gravel bed to be printed is measured, so that this is available in the form of a digital topographical model. The logo can now be recorded with a primary software integrated in a primary means of control on the basis of the measured geographical position. This involves assigning a specific co-ordinate to each pixel of the logo to be placed on the gravel bed by means of transformation.

Next the device 1 travels over the object to be imprinted. In real time, the precise spatial co-ordinates of each individual nozzle of the marking head (print bar) are determined by the satellite positioning system. The software compares these individual co-ordinates with the specified desired co-ordinates of the individual pixels of the logo and each individual dye nozzle is then opened respectively when it is located precisely over the desired position of the georeferenced pixel.

As additional control means deviations can be detected by providing feedback sensors, which for example determine the edge of the previously printed sign, and in the same way corrects them via the software.

In place of, or in addition to, nozzles, a cutter bar could also be used, so that markings are tilled into grassed areas. Also, the nozzles could emit seed instead of dye, in order thus to create a contrast effect depending on the source of the seeds. A coloured powder could also be used, which is baked on after application using the device according to invention.

The invention is sufficiently described with the execution example explained above. Obviously it could also be designed in other variants. So the marking head 5 could be equipped with means such as for example tools for a surface treatment such as roughening, engraving, cutting-in, mowing or similar.

The system also allows the position of an observer or a camera to be taken into account. The proposed markings are prepared accordingly such that they are distorted as required and/or projected onto a piece of land, so that they can be recognized from only approximately a specified position. Thus if a camera was panning for example in a motor race it would only become legible in the final position, which would result in additional attention from the observer.

1. Method for producing markings (15) on a stationary area characterized in that
a marking head (5), with one or more nozzles (6), or other means, arranged on a mobile device (1), for example a vehicle, is moved along the surface to be marked and there are electronic means of control (8) with which the nozzles (6) or the other means of the marking head are controlled in co-ordination with the actual position of the mobile device (1) in accordance with the model to be reproduced and the markings (15) are created.

2. Method according to claim 1, characterised in that the preferably remote-controlled movement of the device (1) is realised by means of a positioning system outside and/or integrated in this latter.

3. Method according to claim 1 or 2, characterised in that the logo is recorded according to the measured geographical position of the area to be marked, with software, that the precise spatial co-ordinates of each individual nozzle of the marking head (5) are determined in real time by means of the positioning system, whereupon the software compares the individual co-ordinates with the specified ideal co-ordinates of the individual pixel of the logo and each individual dye nozzle is then opened respectively, when it is located precisely in the desired position of the georeferenced pixel.

4. Method according to one of the previous claims 1 to 3, characterised in that the device is controlled during the spraying procedure in such a way that it runs in parallel tracks and that at the end of any respective track it is turned and brought into a position which advantageously connects to the previously sprayed track.

5. Method according to one of the previous claims 1 to 3, characterised in that the device follows curving tracks and thus for example prints a stripe of a specified width along a curve.

6. Method according to one of the previous claims 1 to 5, characterised in that large scale specified graphic elements, advantageously with a size of several square metres, are produced.

7. Method according to one of the previous claims 1 to 6, characterised in that the marking (15) is made on the ground, fields, snowfields, posters, textiles, walls, facades or similar.

8. Mobile device for the realisation of the method according to one of the previous claims 1 to 7, characterised in that there is at least one marking head (5) with several nozzles (6) or other means for achieving a marked area, that there is a positioning system for determining the positions of the mobile device (1) and electronic control means (8), with which the nozzles (6) or the other means of the marking head are controlled in co-ordination with the position of the mobile device (1) in accordance with the model to be reproduced.

9. Mobile device according to claim 8, characterised in that the positioning system for the controlled movement of the device (1) is realised by a positioning system contained within the device, and/or by a navigation system via satellite positioning, such as for example GPS or Glonass, and/or by a positioning system placed outside the area to be marked.

10. Mobile device according to claim 8 or 9, characterised in that the marking head (5) is equipped with one or advantageously more spray nozzles for the application of dye or for a partial sowing of plants or similar.

11. Mobile device according to one of the previous claims 8 to 10, characterised in that the marking head (5) is equipped with means such as for example with tools for a surface treatment, such as roughening, engraving cutting-in, mowing or similar.

12. Mobile device according to one of the previous claims 8 to 11, characterised in that the electronic control means (8) includes organs with which the scale reproduction can be adjusted.
